(19) United States
(12) Patent Application Publication
(10) Pub. No.: US 2014/0370482 A1
(43) Pub. Date: Dec. 18, 2014

(54) PEDAGOGICAL ELEMENTS IN VIRTUAL LABS

(71) Applicant: Microsoft Corporation, Redmond, WA (US)

(72) Inventors: Thekkthalackal Varugis Kurien, Sammamish, WA (US); Alpesh Gaglani, Bellevue, WA (US); Arunprakash Balakrishnan, Issaquah, WA (US); Eric . D. Schweickert, Seattle, WA (US); Daniel Behrendt, Bellevue, WA (US); Vinay Balasubramaniam, Issaquah, WA (US); Suyash Sinha, Kirkland, WA (US)

(21) Appl. No.: 13/920,959

(22) Filed: Jun. 18, 2013

(51) Int. Cl. G09B 7/04

(52) U.S. Cl. CPC G09B 7/04
USPC 434/327; 434/322; 434/353

(57) ABSTRACT

A virtual lab is generated for a underlying learning objective defined by a lab instructor. The virtual lab is decomposed into multiple lab steps. Each lab step defines a portion of the underlying learning objective that can be performed independently. Each lab step includes pedagogical information for teaching a learner the portion of the underlying learning objective and information for specifying a portion of the underlying system that will execute the lab step. A first portion of the underlying system is caused to execute a first lab step. This allows the learner to perform the portion of the underlying learning objective defined in the first lab step. An event generated by the learner's performance of the first lab step is received. In response, a specific pedagogical procedure that is dictated by the event is caused to be performed.

### BACKGROUND

Virtual labs are a simulated environment where learners can try and learn new concepts. However, many virtual labs primarily look like service deployments into an infrastructure, but pedagogical aspects such as breaking the lab into separate units, easy assessment mechanisms, user relevance, and reliability are not addressed. This means that there is no simple way to generate a feedback loop between the learner and the lab to adequately address if the learning objective of the lab has been met.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments described herein are related to a method for a virtual lab to use the resources of an underlying system to provide a learning experience to a learner who uses the virtual lab. A virtual lab is generated for an underlying learning objective that is defined by a lab instructor.

The virtual lab is decomposed into multiple lab steps. Each lab step defines a portion of the learning objective that can be performed independently from other portions of the learning objective. Each lab step includes pedagogical information for teaching a learner the portion of the learning objective defined in the lab step and information for specifying a portion of the underlying system that will execute the lab step.

A first portion of the underlying system is caused to execute a first lab step. This allows the learner to perform the portion of the learning objective defined in the first lab step.

An event generated by the learner's performance of the first lab step is received. In response, a specific pedagogical procedure that is dictated by the event is caused to be performed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a computing system in which some embodiments described herein may be employed;

FIG. 2 illustrates a distributed computing system including multiple host computing systems in which some embodiments described herein may be employed;

FIG. 3 illustrates a host computing system that hosts multiple virtual machines and provides access to physical resources through a hypervisor;

FIG. 4 illustrates an example system in which a virtual lab may be defined and provided to a learner;

FIG. 5 illustrates an alternative view of the system of FIG. 4;

FIG. 6 illustrates another alternative view of the system of FIG. 4;

FIG. 7 illustrates a flowchart of an example method for a virtual lab to use the resources of an underlying system to provide a learning experience to a learner who uses the virtual lab; and

FIG. 8 illustrates a flowchart of an example a method for a virtual lab to use the resources of an underlying system to provide an assessment of learning experiences to a learner who uses the virtual lab.

### DETAILED DESCRIPTION

Embodiments described herein disclose methods and systems related to virtual labs. One method is for a virtual lab to use the resources of an underlying system to provide a learning experience to a learner who uses the virtual lab. A virtual lab is generated for a learning objective that is defined by a lab instructor. The virtual lab is decomposed into multiple lab steps. Each lab step defines a portion of the learning objective that can be performed independently. Each lab step includes pedagogical information for teaching a learner the portion of the learning objective defined in the lab step and information for specifying a portion of the underlying system that will execute the lab step. A first portion of the underlying system is caused to execute a first lab step. This allows the learner to perform the portion of the learning objective of the virtual lab defined in the first lab step. An event generated by the learner's performance of the first lab step is received. In response, a specific pedagogical procedure that is dictated by the event is caused to be performed.

Another method is for a virtual lab to use the resources of an underlying system to provide an assessment of learning experiences to a learner who uses the virtual lab. A virtual lab is generated for a learning objective that is defined by a lab instructor. The virtual lab is decomposed into multiple lab steps. Each lab step defines a portion of the learning objective that can be performed independently. Each lab step includes pedagogical information for teaching a learner the portion of the learning objective defined in the lab step and information for specifying a portion of the underlying system that will execute the lab step. A first portion of the underlying system is caused to execute a first lab step. This allows the learner to perform the portion of the learning objective defined in the first lab step. An event generated by the learner's performance of the first lab step is received that indicates that that the first lab step has been completed. In response, an assessment procedure that determines the learner's mastery of the pedagogical information of the first lab step is caused to be performed. The learner is isolated from the virtual lab while the assessment procedure is being performed.

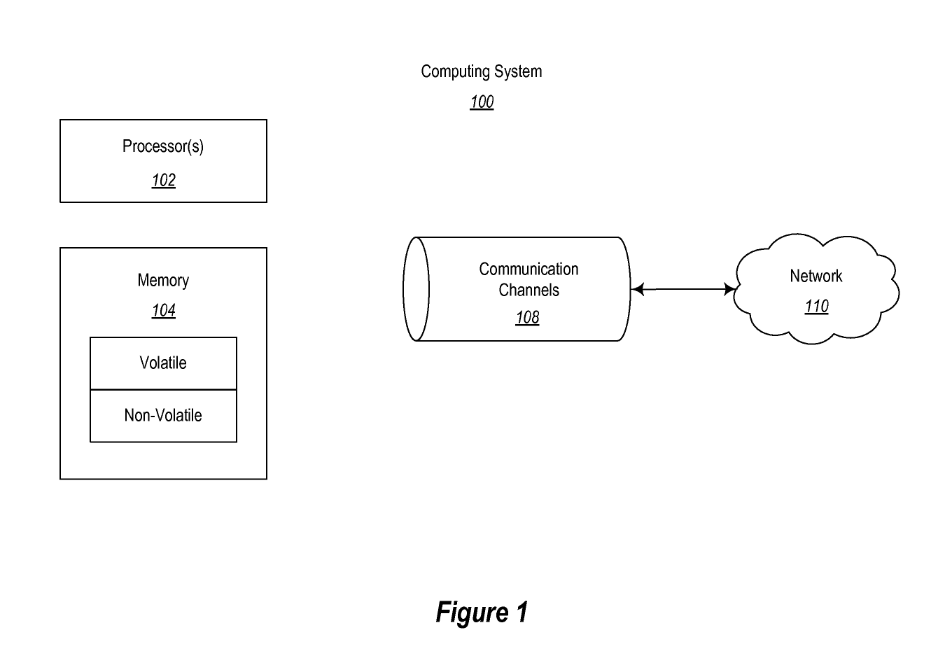

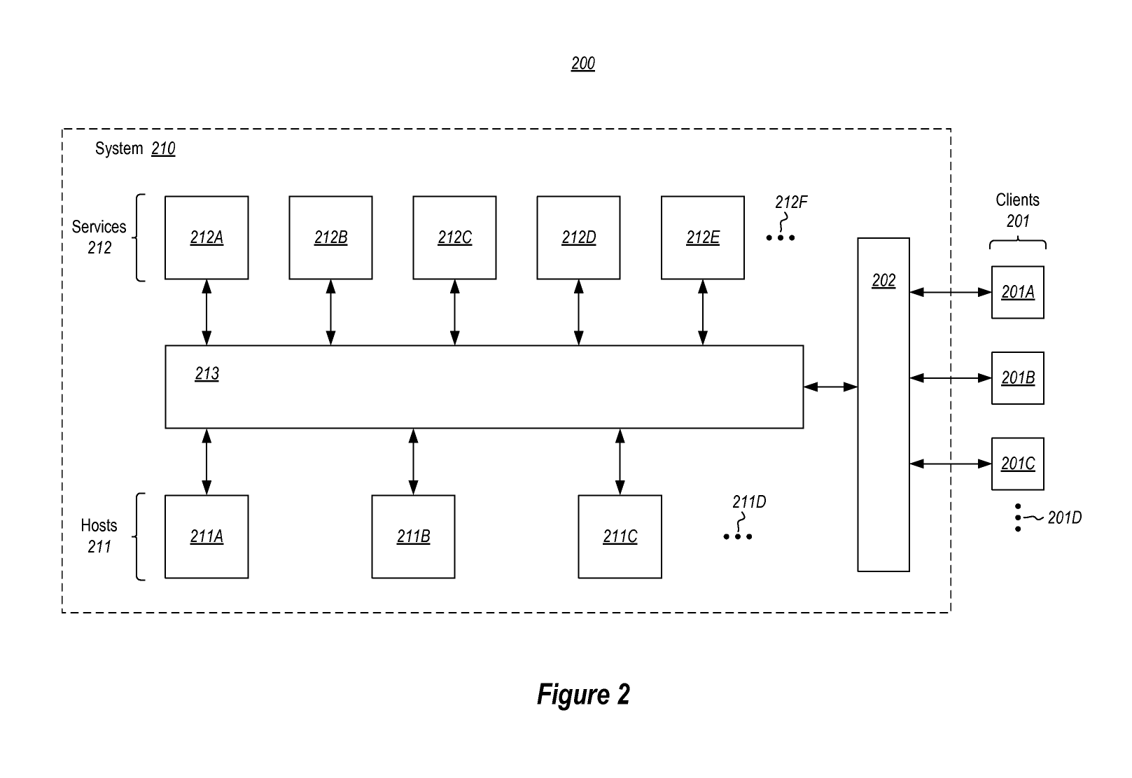

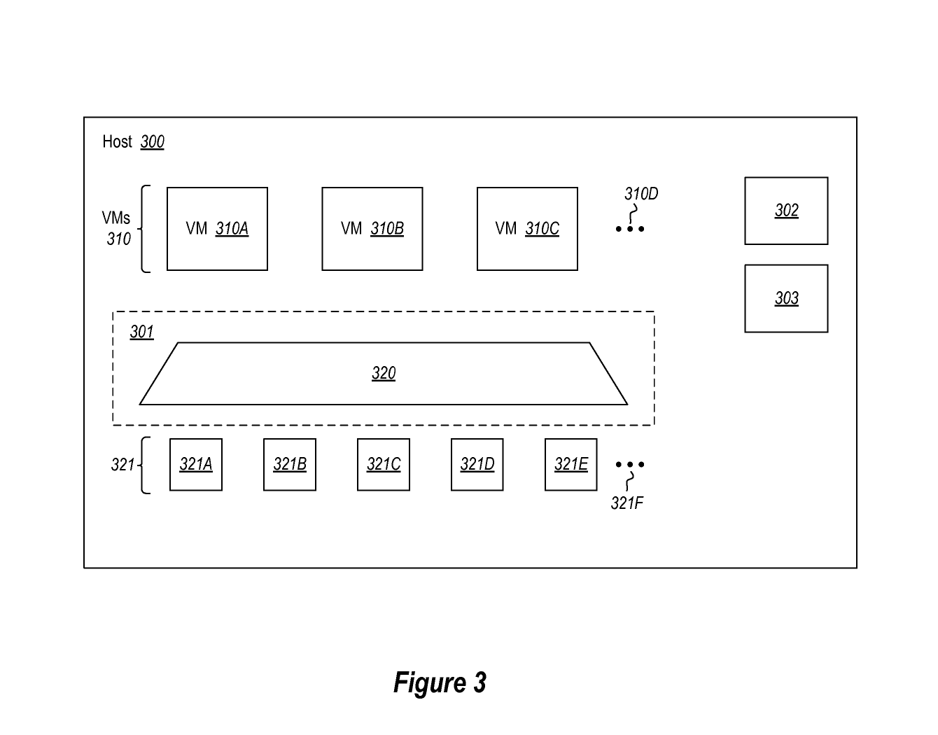

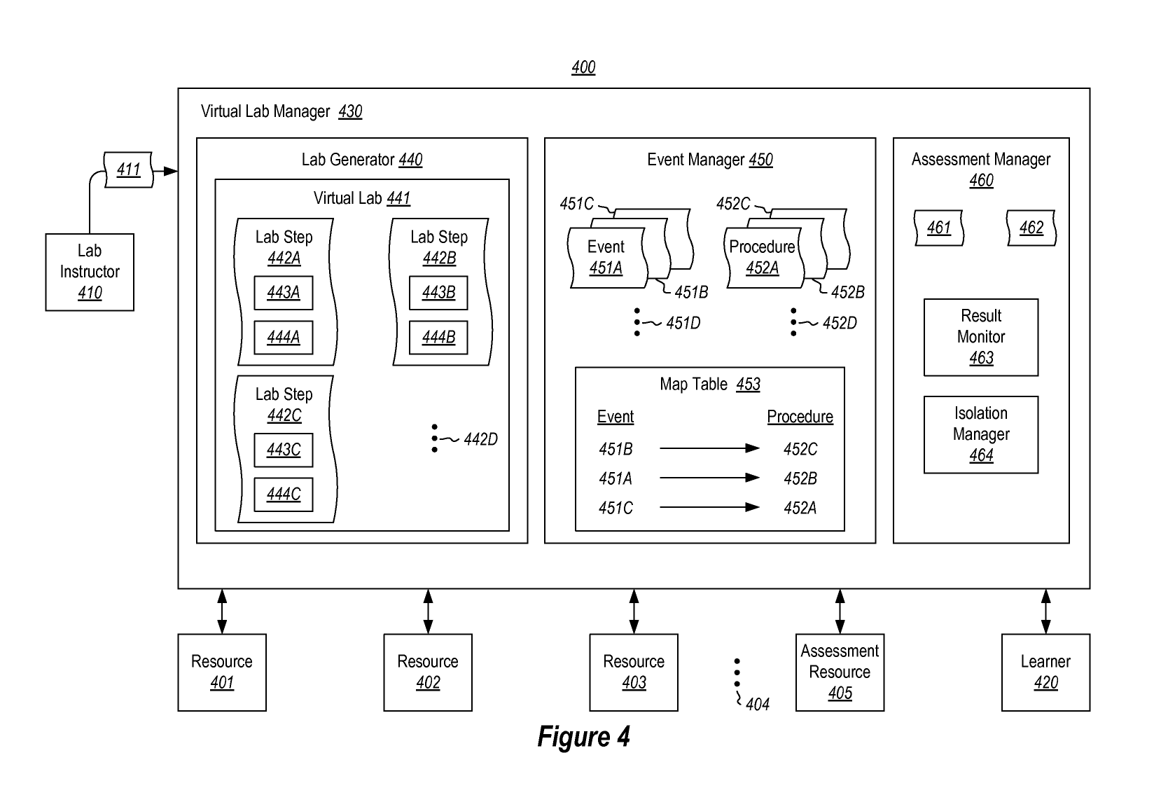

Some introductory discussion of a computing system will be described with respect to FIG. 1. The principles of a distributed computing system will be described with respect to FIG. 2. Then, the principles of operation of virtual machines will be described with respect to FIG. 3. Subsequently, the principles of virtual labs will be described with respect to FIG. 4 and successive figures.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2 abstractly illustrates an environment 200 in which the principles described herein may be employed. The environment 200 includes multiple clients 201 interacting with a system 210 using an interface 202. The environment 200 is illustrated as having three clients 201A, 201B and 201C, although the ellipses 201D represent that the principles described herein are not limited to the number of clients interfacing with the system 210 through the interface 202. The system 210 may provide services to the clients 201 on-demand and thus the number of clients 201 receiving services from the system 210 may vary over time.

Each client 201 may, for example, be structured as described above for the computing system 100 of FIG. 1. Alternatively or in addition, the client may be an application or other software module that interfaces with the system 210 through the interface 202. The interface 202 may be an application program interface that is defined in such a way that any computing system or software entity that is capable of using the application program interface may communicate with the system 210.

The system 210 may be a distributed system, although not required. In one embodiment, the system 210 is a cloud computing environment. Cloud computing environments may be distributed, although not required, and may even be distributed internationally and/or have components possessed across multiple organizations.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

The system 210 includes multiple hosts 211, that are each capable of running virtual machines. Although the system 200 might include any number of hosts 211, there are three hosts 211A, 211B and 211C illustrated in FIG. 2, with the ellipses 211D representing that the principles described herein are not limited to the exact number of hosts that are within the system 210. There may be as few as one, with no upper limit. Furthermore, the number of hosts may be static, or might dynamically change over time as new hosts are added to the system 210, or as hosts are dropped from the system 210. Each of the hosts 211 may be structured as described above for the computing system 100 of FIG. 1.

Each host is capable of running one or more, and potentially many, virtual machines. For instance, FIG. 3 abstractly illustrates a host 300 in further detail. As an example, the host 300 might represent any of the hosts 211 of FIG. 2. In the case of FIG. 3, the host 300 is illustrated as operating three virtual machines 310 including virtual machines 310A, 310B and 310C. However, the ellipses 310D once again represents that the principles described herein are not limited to the number of virtual machines running on the host 300. There may be as few as zero virtual machines running on the host with the only upper limit being defined by the physical capabilities of the host 300.

During operation, the virtual machines emulate a fully operational computing system including an at least an operating system, and perhaps one or more other applications as well. Each virtual machine is assigned to a particular client, and is responsible to support the desktop environment for that client.

The virtual machine generates a desktop image or other rendering instructions that represent a current state of the desktop, and then transmits the image or instructions to the client for rendering of the desktop. For instance, referring to FIGS. 2 and 3, suppose that the host 300 of FIG. 3 represents the host 211A of FIG. 2, and that the virtual machine 310A is assigned to client 201A (referred to herein as “the primary example”), the virtual machine 310A might generate the desktop image or instructions and dispatch such instructions to the corresponding client 201A from the host 211A via a service coordination system 213 and via the system interface 202.

As the user interacts with the desktop at the client, the user inputs are transmitted from the client to the virtual machine. For instance, in the primary example and referring to FIGS. 2 and 3, the user of the client 201A interacts with the desktop, and the user inputs are transmitted from the client 201 to the virtual machine 310A via the interface 201, via the service coordination system 213 and via the host 211A.

The virtual machine processes the user inputs and, if appropriate, changes the desktop state. If such change in desktop state is to cause a change in the rendered desktop, then the virtual machine alters the image or rendering instructions, if appropriate, and transmits the altered image or rendered instructions to the client computing system for appropriate rendering. From the prospective of the user, it is as though the client computing system is itself performing the desktop processing.

The host 300 includes a hypervisor 320 that emulates virtual resources for the virtual machines 310 using physical resources 321 that are abstracted from view of the virtual machines 310. The hypervisor 321 also provides proper isolation between the virtual machines 310. Thus, from the perspective of any given virtual machine, the hypervisor 320 provides the illusion that the virtual machine is interfacing with a physical resource, even though the virtual machine only interfaces with the appearance (e.g., a virtual resource) of a physical resource, and not with a physical resource directly. In FIG. 3, the physical resources 321 are abstractly represented as including resources 321A through 321F. Examples of physical resources 321 including processing capacity, memory, disk space, network bandwidth, media drives, and so forth.

The host 300 may operate a host agent 302 that monitors the performance of the host, and performs other operations that manage the host. Furthermore, the host 300 may include other components 303.

Referring back to FIG. 2, the system 200 also includes services 212. In the illustrated example, the services 212 include five distinct services 212A, 212B, 212C, 212D and 212E, although the ellipses 212F represent that the principles described herein are not limited to the number of services in the system 200. A service coordination system 213 communicates with the hosts 211 and with the services 212 to thereby provide services requested by the clients 201, and other services (such as authentication, billing, and so forth) that may be prerequisites for the requested service.

Attention is now given to FIG. 4, which illustrates a system 400 in which the embodiments disclosed herein may be practiced. The system 400 in one embodiment may correspond to the system described previously in relation to FIG. 2. Accordingly, the system 400 may be implemented in a cloud computing system that includes various virtual machines. However, the system 400 may also be implemented in other computing systems and may be implemented in a combination of computing systems. In addition, the system 400 may be implemented in non-computing systems as well.

The system 400 includes various resources or 401, 402, 403, with ellipses 404 indicating that there may be any number of additional resources. The resources 401, 402, and 403 may be one or more host computers 211 or they may be one or more virtual machines 310. In addition, the resources 401, 402, and 403 may represent one or more tenants of the computing system 400 or one or more services of the computing system 400. As will be explained in more detail to follow, the resources 401, 402, and 403 may be used to execute various lab steps of a virtual lab in accordance with the embodiments disclosed herein. In non-computing systems, the resources 401, 402 and 403 as well as an assessment resource 405 may be any resource that is able to execute or perform the various lab steps.

The system 400 also includes the assessment resource 405. The assessment resource may be one or more host computers 211, one or more virtual machines 310, one or more tenants of the system 400, or one or more services of the system 400. As will be explained in more detail to follow, the assessment resource may be used to assess the performance of a learner 420 who performs the various lab steps of a virtual lab.

The system 400 includes a lab instructor 410. The lab instructor 410 uses the resources of the system 400 to define an underlying learning objective 411 for teaching a learner 420. The underlying learning objective 411 may be any objective the lab instructor intends the learner 420 to learn. For example, in one embodiment the underlying learning objective 411 may be teaching the learner 420 to design a web page using the resources of the system 400. In another embodiment the underlying learning objective 411 may be to teach the learner 420 to program in a particular computer language. It will be appreciated that the embodiments disclosed herein are not limited by the type of learning objective 411.

In some embodiments, the lab instructor 410 may an individual user who designs the underlying learning objective 411. In other embodiments, the lab instructor 410 may be more than one user. In some embodiment, the lab instructor 410 may be an entity such as a tenant or service of the system 400. Accordingly, the lab instructor 410 as illustrated in FIG. 4 is meant to represent any person or entity that uses the system 400 to teach the underlying learning objective 411 to a learner and is also meant to represent the computing and other resources of the system 400 used or controlled by the lab instructor 410. It will be appreciated that the computing resources used by the lab instructor 410 may be implemented in the manner previously discussed in relation to FIGS. 1-3.

The system 400 also includes the learner 420. The learner 420 uses the resources of the system 400 to learn the underlying learning objective 411. The learner 420 may be an individual user or may be more than one user. In addition, the learner may be an entity such as a tenant or service of the system 400. Accordingly, the learner 420 as illustrated in FIG. 4 is meant to represent any person or entity that uses the system 400 to learn the underlying learning objective 411 and is also meant to represent the computing and other resources of the system 400 used or controlled by the learner 420. It will be appreciated that the computing resources used by the learner 420 may be implemented in the manner previously discussed in relation to FIGS. 1-3.

The system 400 includes a virtual lab manager 430. In operation, the virtual lab manager 430 is configured to manage and/or facilitate the interaction of the lab instructor 410, the learner 420, and the various resources of the system 400 in performing a virtual lab as will be explained in more detail to follow. The virtual lab manager 430 may be implemented in a distributed manner in multiple hosts 211 or it may be implemented on a single host. It will be appreciated that the system manager 430 has access to the various processing, storage, and other computing resources of the system 400 as needed. It will also be appreciated that the various components and modules of the virtual lab manager 430 that will be explained in more detail to follow may also be distributed across multiple hosts 211 and will also have access to the various processing, storage, and other computing resources of the system 400 as needed. Further the virtual lab manager 430 may include more or less than the components and modules illustrated and the components and modules may be combined as circumstances warrant.

The virtual lab manager 430 includes a lab generator 440. In operation, the lab generator 440 receives the underlying learning objective 411 from the lab instructor 410 as illustrated in FIG. 4. The lab generator 440 uses the underlying learning objective 411 to generate a virtual lab 441 for the underlying learning objective 411.

The lab generator 440 is also configured to decompose the virtual lab 441 into multiple lab steps according to the learning objective defined by the lab instructor 410. FIG. 4 illustrates three lab steps 442A, 442B, and 442C, which herein after may also be referred to simply as “lab steps 442”. Ellipses 442D represent that there can be any number of additional lab steps 442 as circumstance warrant. Of course, there may also be less than the three lab steps 442A, 442B, and 442C shown in the figure.

The lab steps 442 are typically structured to include a portion or segment of the learning objective 411 that may be performed by the learner 420 independently of any other portion of the learning objective. In other words, each of the lab steps 442 includes a subset of the learning objective that the learner 420 may perform independently of the other subsets to complete the learning objective. In this way, the learner 420 is able to master the overall underlying learning objective 411. In one embodiment, the lab steps 442 are 10-15 minute segments that allow ease of comprehension and scheduling. Of course the lab steps 442 may be other lengths of time as circumstances warrant.

Accordingly, the steps 442 include pedagogical information 443A, 443B, and 443C respectively (hereinafter also referred to as “pedagogical information 443”) that defines and specifies the portion or segment of the learning objective 411 that the instructor 410 desires that the respective lab step teach the learner 420. For example, in the example embodiment of teaching how to design a web page, the pedagogical information 443A of the lab step 442A may specify a first portion of the learning objective that teaches how to identify the elements that are to be included in the web page. The pedagogical information 443B of the lab step 442B may specify a second portion of the learning objective that teaches how to write HTML code for the elements identified in the lab step 442A.

The lab steps 442 also include system resource information 444A, 444B, and 444C respectively (hereinafter also referred to as “resource information 444”). The system resource information 444 is used to identify or configure the resources 401, 402, or 403 that may be used to execute the lab steps 442A, 442B, and 442C.

In one embodiment, the resource information 444 exposes the lab steps 442 to the resources 401, 402, and 403 so that the resources 401, 402, or 403 may execute the lab step if they are able. Alternatively, the resource information 444 may cause the lab steps to be advertised on a service bus or the like to the resources 401, 402, and 403 so that any of the resources that can execute the lab step may do so if the resource is able to. In other embodiments, the resource information 444 may specify a specific resource 401, 402, or 403 that will execute the lab step. In such embodiments, the resource information 444 may be an object that holds the settings of the resources 401, 402, or 403 for the lab step. In some embodiments, the resource information 444 may have a unique identifier that is used to represent each of the resource information 444A, 444B, and 444C.

The virtual lab manager 430 also includes an event manager 450. In operation, the event manager 450 allows the lab instructor 410 to define various events that are generated based on the learner 420's performance of or interaction with the lab steps 442. FIG. 4 shows three events 451A, 451B, and 451C (hereinafter also referred to as “events 451”), with the ellipses 451D illustrating that there may be any number of additional events. It will be appreciated that there may also be less than three events 451. Specific examples of the events 451 will be explained in more detail to follow.

The event manager 450 also allows the lab instructor to define various pedagogical procedures whose performance is dictated by the events 451 that occur while the lab steps 442 are being performed. FIG. 4 shows three pedagogical procedures 452A, 452B, and 452C (hereinafter also referred to as “pedagogical procedures 452”), with the ellipses 452D illustrating that there may be any number of additional pedagogical procedures. It will be appreciated that there may also be less than three pedagogical procedures 452. Specific examples of the pedagogical procedures 452 will be explained in more detail to follow.

The event manager 450 also includes a map table 453 that maps an event 451 with the specific pedagogical procedure 452 for that event. This helps to ensure that the appropriate specific pedagogical procedure 452 will be called for a given event that is generated by the learner's performance of a lab step 442. For example, the map table 453 shows that the pedagogical procedure 452C should be called when the event 451B occurs, that the pedagogical procedure 452B should be called when the event 451A occurs, and that the pedagogical procedure 452A should be called when the event 451C occurs. Of course, it will be appreciated that in some embodiments there may more than one event that calls a specific pedagogical procedure and there may be more than one pedagogical procedure that is appropriate for a given event.

Once a specific pedagogical procedure 452 has been called in response to the event, the event manager 450 causes that the specific pedagogical procedure 452 is performed. In some embodiments, the event manager 450 causes the performance of the specific pedagogical procedure 452 by utilizing one of the resources 401, 402, or 403 to perform the procedure. The resources 401, 402, or 403 performing the specific pedagogical procedure 452 may be the same resource that was performing the lab step 442 when the event 451 was generated or it can be a different resource. In other embodiments, the event manager 450 causes the performance of the specific pedagogical procedure 452 by utilizing the computing or other resources of the virtual lab manager 430 or another portion of the system 400.

In many embodiments, the lab instructor 410 will desire to know if the learner 420 has mastered the portion of the learning objective defined in each lab step 442. Accordingly, the virtual lab manager 430 includes an assessment manager 460, which is configured to manage a specific type of an event 451, namely an event 461 that indicates that the learner 420 has reached the end of a lab step 442. When the end of a lab step event 461 is generated by the learner's completion of a lab step 442, the assessment manager 460 causes that an assessment procedure 462, which may be a specific type of a specific pedagogical procedure 452, is performed. The assessment procedure 462 assesses the level of mastery that the learner 420 has achieved of the pedagogical information 443 of the lab step 442.

In some embodiments, the assessment manager 460 causes the performance of the assessment procedure 462 by utilizing the assessment resource 405 to perform the assessment procedure. The assessment resource 405 performing the specific pedagogical procedure 452 may be the same resource that was performing the lab step 442 when the end of a lab step event 461 was generated or it may be a different resource. In other embodiments, the assessment manager 460 causes the performance of the assessment procedure 462 by utilizing the computing or other resources of the virtual lab manager 430.

The assessment manager 460 also includes a results monitor 463. In operation, the results monitor 463 analyzes the results of the assessment procedure 462 to determine if the learner 420 has achieved a sufficient level of mastery of a lab step 442 to infer that the learner 420 has learned the pedagogical information 443 of that lab step. In some embodiments, this determination may be based on a demonstration of the pedagogical information 443 by the learner 420 that passes a predefined threshold. In other embodiments, this determination may be based on the learner 420 passing an exam. In other embodiments, this determination may be based on the results being sufficient based on a curve or relative to other learners who are learning the pedagogical information 443. For example, in the embodiment of designing a web page, the learner 420 may need to demonstrate correctly writing HTML code in order to pass the lab step 442B previously discussed or the learner 420 may need to achieve a score that is high enough on a curve to show mastery.

Regardless of how the determination is made, the results monitor 463 provides the result to the lab instructor 410 so that the lab instructor may take appropriate action. In some embodiments, if the lab step 442 was not sufficiently mastered, the lab instructor 410 may require that the lab step be taken again.

In some embodiments when the learner 420 has shown sufficient mastery of the lab step 442, the results monitor 463 makes the next lab step 442 of the virtual lab 441 available to the learner 420. The next lab step 442 may be executed by a resource 401, 402, or 403 as previously explained. In one embodiment, the various lab steps 442 are performed by the learner 420 in a sequential manner. For example, once the learner 420 has shown sufficient mastery of the lab step 442A, the lab step 442B will be made available to the learner. Accordingly, the learner 420 will perform each lab step 442 in a sequential manner until all of the lab steps are completed.

In an alternative embodiment, however, the results monitor 463 may include branching logic. In such embodiments, the results monitor 463 monitors the assessment procedure 462 as described. However, rather than just sequentially make the lab steps 442 available to the learner, the branching logic of the result monitor 463 may determine which lab step 442 to provide next based on the results of the previous lab step. For example, in the example of designing a web page if the learner 420 has demonstrated a total mastery of writing HTML code, then the lab monitor 463 may determine that the next lab step in the design process should be next. However, if the learner 420 has shown only a partial mastery of writing HTML code, then perhaps the lab monitor 463 may determine that a lab step that further teaches HTML code writing should be next. In some embodiments, the branching logic of the results monitor may determine a next lab step 442 based on one or more of the events 451 that are not related to the end of a lab step.

Once the learner 420 has shown sufficient mastery of all the lab steps 442 to at least infer that the learner has learned the underlying learning objective 411 of the virtual lab 441, the lab manager 430 notifies the lab instructor 410 of this so that the lab instructor may provide the learner 420 with an award or other recognition. The lab instructor 410 may utilize the resources 401, 402, and/or 403 to provide the award. The lab manager 430 also may advertise the completion of the virtual lab 441 to the resources 401, 402, and/or 403, which may decide to provide the learner 420 with an award.

The assessment manager 460 also includes an isolation manager 464. In operation, the isolation manager 464 temporarily isolates the learner 420 from the virtual lab 441 by disconnecting the learner 420 from the virtual lab 441 while the assessment procedure 462 is being performed by the assessment resource 405 and/or the assessment manager 460. This isolation is done to prevent the learner 420 from tampering with the assessment procedure in an attempt to influence the results of the assessment or to influence the reporting of the results of the assessment. For example, the isolation prevents the learner 420 from causing the assessment procedure to return a result that shows a sufficient mastery of a lab step 442 when the learner has not actually mastered the lab step. In one embodiment, the isolation manager 464 uses the isolation mechanisms provided by the system 400 such as the hypervisor 320 that provides isolation for the virtual machines 310. In one embodiment, the assessment procedure 462 may run on a host partition that is isolated or separate from the host partition of the learner 420.

The isolation manager 464 monitors the learner 420 while the assessment procedure 462 is being performed. When the assessment is complete and the results are returned to the results monitor 463, the isolation manager 464 will reconnect the learner to the virtual lab 441 so that the learner 420 is no longer isolated from the virtual lab 441 and is able to perform the next lab step 442. However, if the isolation manager 464 determines that the learner 420 attempted to access the assessment procedure while it was being performed, the isolation manager 464 may continue to isolate the learner 420 from the virtual lab 441 or may shut down the virtual lab manager 430 until the lab instructor 410 determines why the learner 420 attempted to access the assessment procedure.

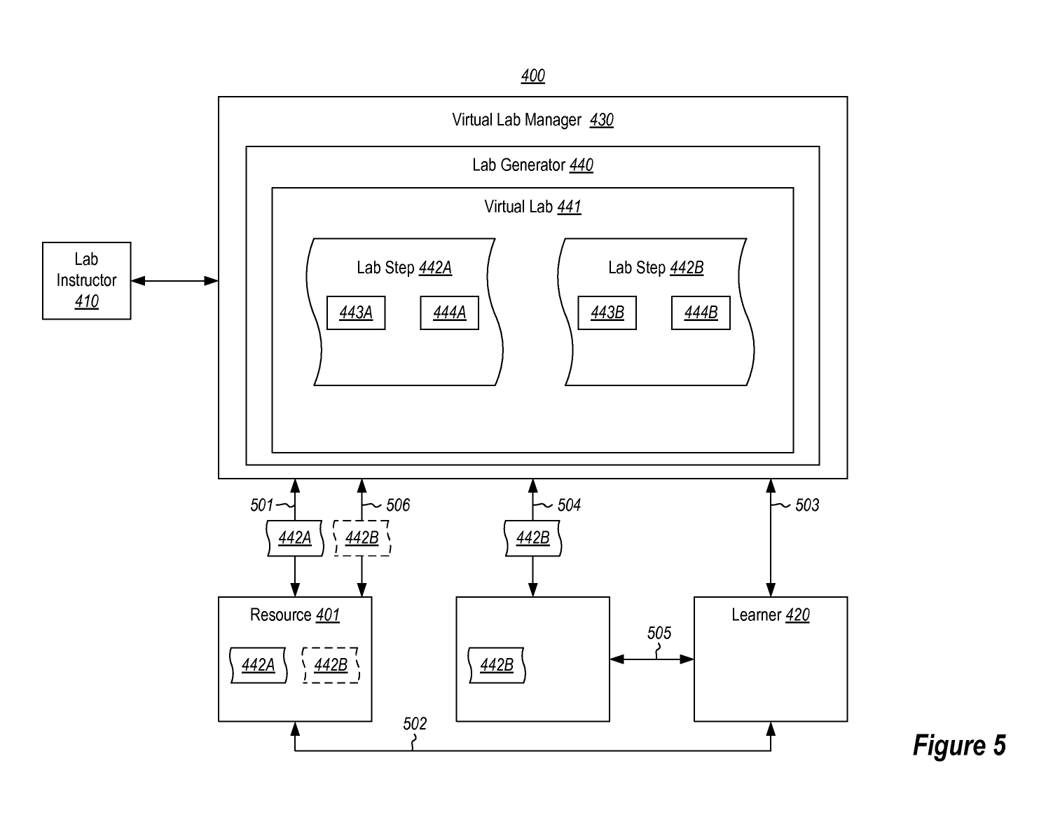

Attention is now given to FIG. 5, which shows an alternative view of the system 400 and which omits some elements shown in FIG. 4 for ease of explanation. FIG. 5 illustrates a process flow for causing the resources of the system 400 to execute various lab steps 442. As previously described, the lab generator 440 decomposes the virtual lab 441 into the various lab steps 442, which each include the pedagogical information 443 for teaching a portion of the underlying learning objective 411 and resource information 444 that identifies or configures the resources 401, 402, or 403 to execute the lab steps 442. As shown in FIG. 5, the lab generator 440 exposes, advertises, or otherwise makes the lab step 442A available to the resources 401 and 402. As also shown in FIG. 5 by the interaction 501, the resource 401 is able to execute the lab step 442A, which in the example of designing a web page may be to identify the elements of the web page.

FIG. 5 further shows by the interaction 502 that the learner 420 is able to use the resource 401 to access and perform the portion of the underlying learning objective 411 defined in the lab step 442A. The interaction 503 indicates that the lab manager 430 may also be involved in facilitating the learner 420's performance of the lab step 442A.

FIG. 5 shows that the lab generator 440 also exposes, advertises, or otherwise makes the lab step 442B available to the resources 401 and 402. This may occur after the successful completion of an assessment procedure as previously described, although this is not required as the lab step 442B may be exposed, advertised, or otherwise made available prior to the successful completion of an assessment procedure for a different lab step. As shown in FIG. 5 by the interaction 504, the resource 402 is able to execute the lab step 442B, which in the example of designing a web page may be to write HTML code for the identified elements of the web page.

FIG. 5 further shows by the interaction 505 that the learner 420 is able to use the resource 402 to access and perform the portion of the underlying learning objective 411 defined in the lab step 442B. The interaction 503 indicates that the lab manager 430 may also be involved in facilitating the learner 420's performance of the lab step 442B.

As mentioned previously, the lab steps 442A and 442B may both be executed by the same resource. For example, in FIG. 5 the dashed interaction 506 is to illustrate that the lab step 442B may be executed by the resource 401 instead of the resource 402 and that the resource 401 may execute both the lab steps 442A and 442B. Although the resources 401 and 402 are shown as being separate, in some embodiments the resources 401 and 402 as well as the resources 403 and 404 may be part of the same tenant or other entity of the system 400. In some embodiments, the resources 401, 402, 403, and 404, or a subset thereof, may be under the control of the lab instructor 410 or an entity that controls the virtual lab manager 430.

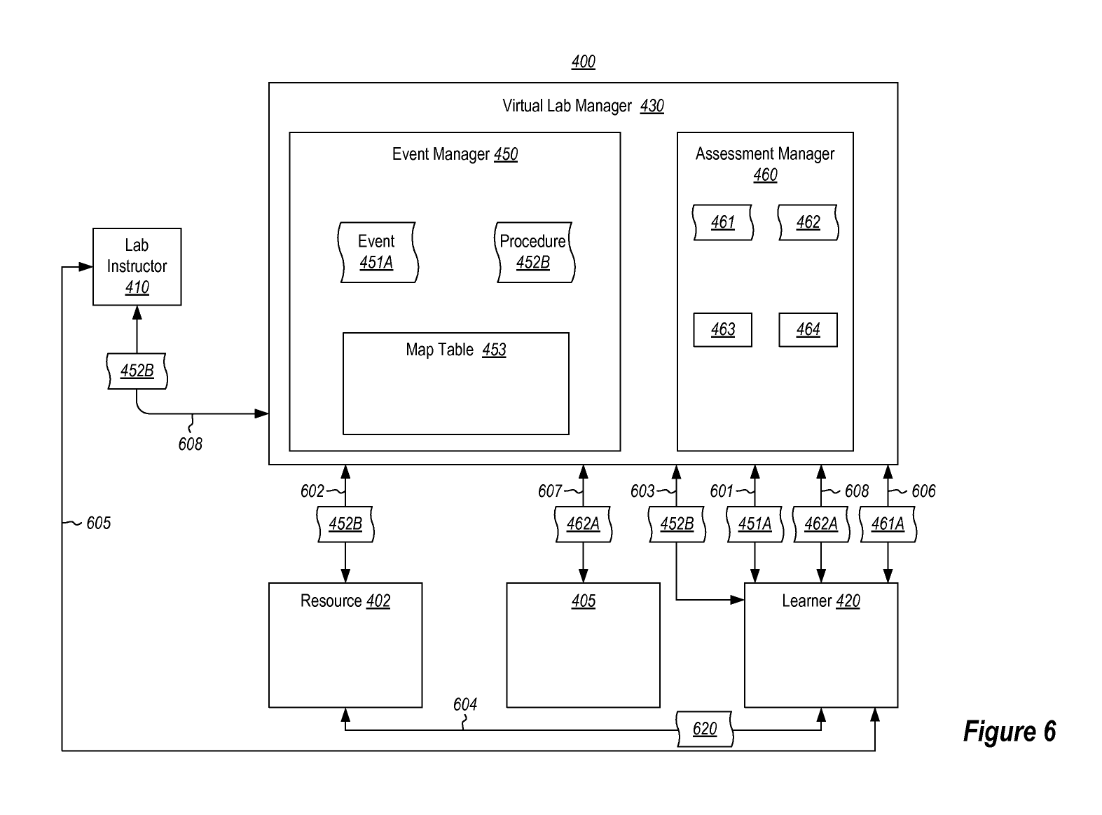

Attention is now given to FIG. 6, which shows an alternative view of the system 400 and which omits some elements shown in FIG. 4 for ease of explanation. FIG. 6 illustrates a process flow for specific examples of the events 451 and the associated procedures 452 and an end of lab step event 461 and the assessment procedure 462. As illustrated by interaction 601, the learner 420 causes the generation of an event 451A based on the learner's performance of or interaction with one of the lab steps 442. Although the event 451A is shown as being directly generated by the learner 420 or the resources of the learner 420, this for ease of explanation only and it will be appreciated that the learner's performance of or interaction with one of the lab steps 442 may cause a resource, such as resource 402, that is executing the lab step to generate the event or may cause another resource of the system 400 to generate the event.

In response to receiving the event 451A, the virtual lab manager 430 uses the map table 453 to determine which of the specific pedagogical procedures 452 are appropriate for the event. In the illustrated example, the specific pedagogical procedure 452B is mapped to the event 451A (FIG. 4). Accordingly, the virtual lab manager 430 causes the specific pedagogical procedure 452B to be performed by the system 400 in response to the event 451A. As illustrated in FIG. 6, in some embodiments as indicated by interaction 602 the specific pedagogical procedure 452B is performed by a resource of the system 400 such as resource 402. In some embodiments, the resource performing the specific pedagogical procedure may be different from the resource that executes the lab step 442 that is being performed when the event is generated and in other embodiments the resource performing the specific pedagogical procedure may be the same as the resource that executes the lab step 442 that is being performed when the event is generated.

In other embodiments, the specific pedagogical procedure 452B may be performed by the resources of the learner 420 as indicated by interaction 603, by the resources of the lab instructor 410 as indicated by interaction 608, or by the resources of the virtual lab manager 430. An interaction 604 illustrates that the learner 420 and the resource 402 may interact while the specific pedagogical procedure 452B is being performed.

In one embodiment, the event 451A may be an event that specifies that all of the lab steps 442 have been successfully mastered by the leaner 420. In response to the event 451A, the virtual lab manager 430 causes the resource 402 to perform the specific pedagogical procedure 452B. In this embodiment, the specific pedagogical procedure 452B is a procedure that generates an award or other recognition for the learner 420 in recognition of successfully completing the virtual lab 441 and learning the underlying learning objective 411 and the resource 402 is a resource able to generate the reward. Accordingly, as illustrated the resource 402 performs the specific pedagogical procedure 452B and then provides an award or other recognition 620 to the learner 420. The award 620 may be any reasonable award.

In some embodiments, the virtual lab manager 430 publishes that the leaner 420 has successfully completed the virtual lab 441 on an underlying service bus of the system 400. The resource 402 may subscribe events showing the completion of the lab 441. In response to being informed that the learner 420 has successfully completed the virtual lab 441, the resource 420 may provide the award 620. Thus, a publish-subscribe pattern may be considered an embodiment of the virtual lab manager 430 causing the resource 402 to perform the specific pedagogical procedure 452B.

In another embodiment, the learner 420 may desire to rewind or restart the lab step 442 so that the learner can redo the lab step. Redoing the lab step may help the learner 420 to better understand the pedagogical information of the lab step. Accordingly, the event 451A may be an event that specifies that the learner 420 has restarted the lab step that is currently being performed.

In response to the event 451A, the virtual lab manager 430 causes that a specific pedagogical procedure 452B dictated by this event is performed. In this embodiment, the specific pedagogical procedure 452B returns the lab step to a beginning state or to some other state that occurred before the learner restarted the lab step. This may erase or remove any information that has been generated in the lab step prior to restarting the lab step. In this way, the learner 420 is able to have a fresh start at learning the pedagogical information of the lab step by returning to the beginning state or the other state that occurred before the learner restarted the lab step.

In another embodiment, the learner 420 may desire to contact the lab instructor 410 to ask a question or to request information that is needed for the lab step 442 being performed. Accordingly, the event 451A may be an event that specifies that the learner 420 has made the request for information to the lab instructor.

In response to the event 451A, the virtual lab manager 430 causes that a specific pedagogical procedure 452B dictated by this event is performed. In this embodiment, the specific pedagogical procedure 452B notifies the lab instructor 410 of the request and provides the request for information or the question to the lab instructor 410 as indicated by the interaction 608. The lab instructor 410 is then able to provide the needed information or to answer the question as indicated by interaction 605 with the learner 420.

In another embodiment, the learner 420 may deviate from the portion of the underlying learning objective 411 defined in the lab step 442 being performed. This may happen because the learner 420 is confused or does not understand what is being taught. Alternatively, the learner 420 may be maliciously trying to circumvent the learning objective. In either situation, it is beneficial to notify or inform the lab instructor 410 of the deviation. Accordingly, the event 451A may be an event that specifies that the learner 420 has deviated from the portion of the underlying learning objective 411 defined in the lab step 442 being performed.

In response to the event 451A, the virtual lab manager 430 causes that a specific pedagogical procedure 452B dictated by this event is performed. In this embodiment, the specific pedagogical procedure 452B notifies the lab instructor 410 of the deviation as indicated by the interaction 608. The lab instructor 410 is then able to provide instructions to the learner 420 as indicated by interaction 605 that will provide the learner 420 with remedial help if needed or that will prevent the circumvention of the learning objective.

In most embodiments, whenever the learner 420 ends a session without completing the lab step 442 being performed when the session ends, an event 451A is generated. There may be several reasons why the session has ended. For example, the resources 401, 402, or 403 executing the lab step 442 or another portion of system 400 could have experienced system problems, the learner 420 may lose power, or the learner 420 may simply disconnect from the virtual lab 441. Accordingly, the event 451A may be an event that notifies the lab manager 430 that the learner 420 has been disconnected from the system without completing the lab step 442 being performed.

In response to the event 451A, the virtual lab manager 430 causes that a specific pedagogical procedure 452B dictated by this event is performed. In this embodiment, the specific pedagogical procedure 452B attempts to determine the cause of the disconnection and then to take any available remedial actions. For example, the virtual lab manager 430 may store the current state of the lab step 442 so that the learner can return to that state when reconnected. The virtual lab manager 430 may take other remedial actions as needed.

As previously discussed, when the learner 420 completes a lab step 442, an end of lab step event 461 is generated as shown by interaction 606. In response to the end of lab step event 461, the virtual lab manager 430 causes the assessment procedure 462 to be performed. In one embodiment, the assessment procedure 462 is performed by the assessment resource 405 as indicated by interaction 607. However, the assessment resource may also be performed by other portions of the system 400.

As previously discussed, the isolation manager 464 isolates the learner 420 from the system while the assessment procedure 462 is being performed. This isolation is illustrated in FIG. 6 by the fact that there is no interaction between the learner 420 and assessment resource 405.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

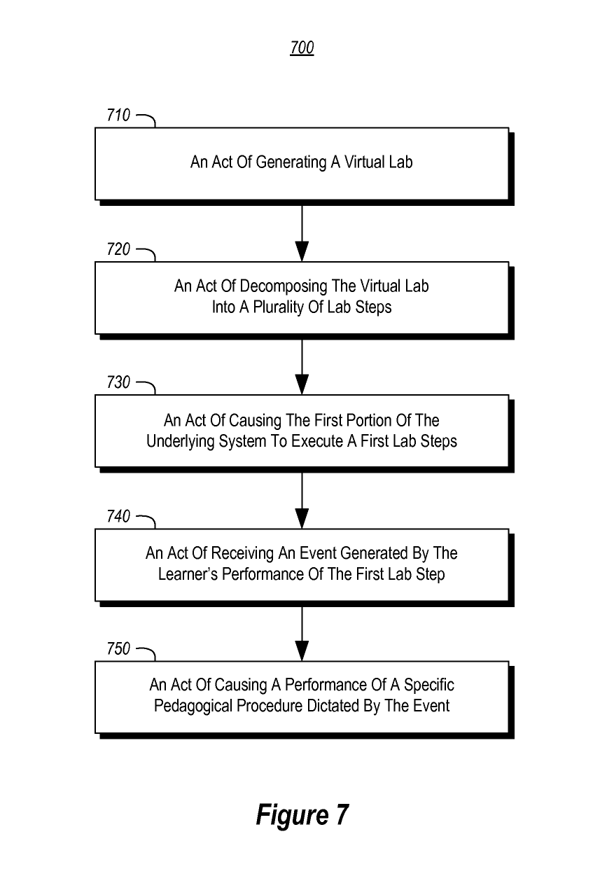

FIG. 7 illustrates a flow chart of an example method 700 for a virtual lab to use the resources of an underlying system to provide a learning experience to a learner who uses the virtual lab. The method 700 will be described with the respect to the system 400 described above.

The method 700 includes an act of generating a virtual lab for an underlying learning objective defined by a lab instructor (act 710). For example as explained previously the lab generator 440 of the virtual lab manager 430 generates the virtual lab 441 for an underlying learning objective 411 determined by the lab instructor 410. As discussed, the underlying learning objective 411 may be any learning objective determined by the lab instructor 410.

The method 700 includes an act of decomposing the virtual lab into a plurality of lab steps (act 720). Each lab step defines a portion of the underlying learning objective that can be performed independently from other portions of the underlying learning objective. Each lab step includes pedagogical information for teaching the learner the portion of the underlying learning objective and includes information specifying a first portion of the underlying system that will execute each lab step. For example, as previously described the lab generator 440 decomposes the virtual lab 441 into the various lab steps 442A, 442B, 442C, and potentially 442D. Each of the lab steps 442 defines a portion of the underlying learning objective 411 that may be performed independently and separately from other portions of the underlying learning objective defined in other lab steps 442. Each lab step 442 includes pedagogical information 443 that teaches the learner the portion of the underlying learning objective. The lab steps 442 also include resource information 444 for specifying the portion of system 400 that will execute the lab step as previously described.

The method 700 includes an act of causing the first portion of the underlying system to execute a first lab step of the plurality of lab steps to thereby allow the learner to perform the portions of the underlying learning objective defined in the first lab step (act 730). For example, as previously described the virtual lab manager 430 causes the resources 401, 402, and/or 403 to execute one of the lab steps 442 so that learner 420 can perform the portions of the underlying learning objective 411 to thereby learn the portion of learning objective.

The method 700 includes an act of receiving an event generated by the learner's performance of the first lab step of the plurality of lab steps (act 740). For example an event 451 may be generated by various actions of the learner 420 while performing a lab step 442 in the various manners previously described.

The method 700 includes an act of causing a performance of a specific pedagogical procedure dictated by the event (act 750). For example, as previously described the virtual lab manager 430 uses the map table 453 to determine an appropriate specific pedagogical procedure 452 for the event 451. The virtual lab manager 430 then causes a portion of the system 400 to perform the specific pedagogical procedure 452 in the manner previously described.

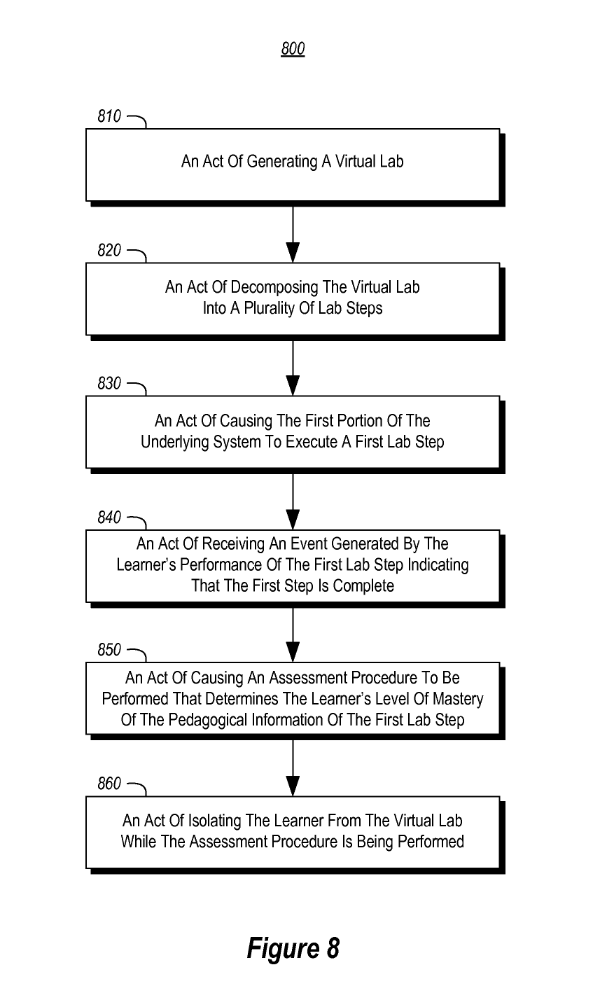

FIG. 8 illustrates a flow chart of an example method 800 for a virtual lab to use the resources of an underlying system to provide an assessment of learning experiences to a learner who uses the virtual lab. The method 800 will be described with the respect to the system 400 described above.

The method 800 includes an act of generating a virtual lab for an underlying learning objective defined by a lab instructor (act 810). For example as explained previously the lab generator 440 of the virtual lab manager 430 generates the virtual lab 441 for an underlying learning objective 411 determined by the lab instructor 410. As discussed, the underlying learning objective 411 may be any learning objective determined by the lab instructor 410.

The method 800 includes an act of decomposing the virtual lab into a plurality of lab steps (act 820). Each lab step defines a portion of the underlying learning objective that can be performed independently from other portions of the underlying learning objective. Each lab step includes pedagogical information for teaching the learner the portion of the underlying learning objective and includes information specifying a first portion of the underlying system that will execute each lab step. For example, as previously described the lab generator 440 decomposes the virtual lab 441 into the various lab steps 442A, 442B, 442C, and potentially 442D. Each of the lab steps 442 defines a portion of the underlying learning objective 411 that may be performed independently and separately from other portions of the underlying learning objective defined in other lab steps 442. Each lab step 442 includes pedagogical information 443 that teaches the learner the portion of the underlying learning objective. The lab steps 442 also include resource information 444 for specifying the portion of system 400 that will execute the lab step as previously described.

The method 800 includes an act of causing the first portion of the underlying system to execute a first lab step of the plurality of lab steps to thereby allow the learner to perform the portions of the underlying learning objective defined in the first lab step (act 830). For example, as previously described the virtual lab manager 430 causes the resources 401, 402, and/or 403 to execute one of the lab steps 442 so that learner 420 can perform the portions of the underlying learning objective 411 to thereby learn the portion of learning objective.

The method 800 includes an act of receiving an event generated by the learner's performance of the first lab step of the plurality of lab steps indicating that the first lab step has been completed (act 840). For example an end of lab step event 461 may be generated by the learner 420 completing a lab step 420 as previously described.

The method 800 includes in response to receiving the event, an act of causing an assessment procedure to be performed that determines the learner's level of mastery of the pedagogical information of the first lab step (act 850). For example, virtual lab manager 430 causes the performance of the assessment procedure 462 in the manner previously described.

The method 800 includes an act of isolating the learner from the virtual lab such that learner has no access to the virtual lab while the assessment procedure is being performed (act 860). For example, the isolation manager 464 isolates the learner 420 while the assessment procedure is being performed. In one embodiment, the isolation manager disconnects the learner 420 from the virtual lab 441. When the assessment procedure is completed and the results have been returned to the virtual lab manager 430, the isolation manager removes the isolation from the learner 420.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for a virtual lab to use the resources of an underlying system to provide a learning experience to a learner who uses the virtual lab, the method comprising:
an act of generating a virtual lab for an underlying learning objective defined by a lab instructor;
an act of decomposing the virtual lab into a plurality of lab steps, each lab step defining a portion of the underlying learning objective that can be performed independently from other portions of the underlying learning objective, each lab step including pedagogical information for teaching the learner the portion of the underlying learning objective defined in the lab step and including information specifying a first portion of the underlying system that will execute each lab step;
an act of causing the first portion of the underlying system to execute a first lab step of the plurality of lab steps to thereby allow the learner to perform the portion of the underlying learning objective defined in the first lab step;
an act of receiving an event generated by the learner's performance of the first lab step of the plurality of lab steps; and
an act of causing a performance of a specific pedagogical procedure dictated by the event.

2. The method of claim 1, wherein the specific pedagogical procedure is performed by a second portion of the underlying system.

3. The method of claim 2, wherein the event is an event specifying that the first lab step has been completed by the learner, the method further comprising:
an act of causing the second portion of the underlying system to perform as the specific pedagogical procedure an assessment procedure that determines if the first lab step has been correctly performed by the learner;
an act of isolating the learner from the virtual lab such that learner has no access to the virtual lab while the assessment procedure is being performed; and
an act of no longer isolating the learner from the virtual lab once the assessment procedure is complete.

4. The method of claim 2, wherein the second portion of the underlying system is the same as the first portion of the underlying system.

5. The method of claim 2, wherein the event is an event specifying that the plurality of lab steps have been completed by the learner, the method further comprising:
an act of causing the second portion of the underlying system to perform as the specific pedagogical procedure a procedure that generates an award for the learner; and
an act of providing the award to the learner.

6. The method of claim 1, wherein the event is an event specifying that the learner has deviated from the portion of the underlying learning objective defined in the first lab step, the method further comprising:
an act of performing as the specific pedagogical procedure a procedure that notifies the lab instructor of the deviation; and
an act of providing instructions from the lab instructor to the learner.

7. The method of claim 1, wherein the event is an event specifying that the learner has returned to the beginning of the first lab step, the method further comprising:
an act of performing as the specific pedagogical procedure a procedure that removes information related to the first lab step that the learner has created within the first lab step prior to the learner returning to the beginning of the first lab step; and
an act of returning to first step to a start state.

8. The method of claim 1, wherein the event is an event specifying that the learner desires to make a request for information to the lab instructor, the method further comprising:
an act of performing as the specific pedagogical procedure a procedure that notifies the lab instructor of the request; and
an act of providing information from the lab instructor to the learner.

9. The method of claim 1, wherein the event is an event specifying that the learner has been disconnected from the virtual lab, the method further comprising:
an act of performing as the specific pedagogical procedure a procedure that determines the cause of the disconnection; and
an act of performing remedial actions.

10. The method of claim 1, wherein the lab instructor who defines the underlying learning objectives in control of the first portion of the underlying system.

11. The method of claim 1, wherein the underlying system is a computing system that includes virtual machines.

12. A method for a virtual lab to use the resources of an underlying system to provide an assessment of learning experiences to a learner who uses the virtual lab, the method comprising:
an act of generating a virtual lab for an underlying learning objective defined by a lab instructor;
an act of decomposing the virtual lab into a plurality of lab steps, each lab step defining a portion of the underlying learning objective that can be performed independently from other portions of the underlying learning objective, each lab step including pedagogical information for teaching the learner the portion of the underlying learning objective defined in the lab step and including information specifying a first portion of the underlying system that will execute each lab step;
an act of causing the first portion of the underlying system to execute a first lab step of the plurality of lab steps to thereby allow the learner to perform the portion of the underlying learning objective defined in the first lab step;
an act of receiving an event generated by the learner's performance of the first lab step of the plurality of lab steps indicating that the first lab step has been completed;
in response to receiving the event, an act of causing an assessment procedure to be performed that determines the learner's level of mastery of the pedagogical information of the first lab step; and
an act of isolating the learner from the virtual lab such that learner has no access to the virtual lab while the assessment procedure is being performed.

13. The method of claim 12, further comprising:
an act of no longer isolating the learner from the virtual lab once the assessment procedure is complete.

14. The method of claim 12, further comprising:
an act of detecting that the learner is attempting to access the assessment procedure while the assessment procedure is being performed; and
in response, an act of continuing to isolate the learner from the virtual lab.

15. The method of claim 12, further comprising:
an act of receiving a second event generated by the learner's interaction with the first lab step of the plurality of lab steps; and
in response to receiving the second event, an act of causing a performance of a specific procedure dictated by the learner's performance of the first lab step.

16. The method of claim 12, further comprising:
an act of detecting that the learner is attempting to access the assessment procedure while the assessment procedure is being performed; and
in response, an act of shutting down the virtual lab.

17. The method of claim 12, further comprising:
an act of determining, based on the assessment procedure, that the learner has an acceptable level of mastery of the of the pedagogical information of the first lab step; and
an act of making a second lab step of the plurality of lab steps available to the learner so that the learner can perform the portions of the underlying learning objective defined in the second lab step.

18. The method of claim 17, wherein the second lab step is one of:
a lab step that sequentially follows the first lab step in the virtual lab; or
a lab step that is determined based on the results of the assessment of the first lab step.

19. A system, the system comprising:
one or more computing resources of an underlying system;
one or more processors;
a lab instructor who defines an underlying learning objective;
a learner who is intended to learn the learning objective; and
a virtual lab manager, the virtual lab manager comprising at least a lab generator, an event manager, and an assessment manager, the virtual lab manager configured to perform the following:
generate a virtual lab for the underlying learning objective;
decompose the virtual lab into a plurality of lab steps, each lab step defining a portion of the underlying learning objective that can be performed independently from other portions of the underlying learning objective, each lab step including pedagogical information for teaching the learner the portion of the underlying learning objective defined in the lab step and including information specifying which portion of the one or more computing resources will execute each lab step;
cause the specified portion of the one or more computing resources to execute a first lab step of the plurality of lab steps to thereby allow the learner to perform the portion of the underlying learning objective defined in the first lab step;
receive a first event generated by the learner's performance of the first lab step of the plurality of lab steps;
cause a performance of a specific pedagogical procedure dictated by the first event;
receive a second event generated by the learner's performance of the first lab step of the plurality of lab steps, the second event indicating that the first lab step has been completed;
cause an assessment procedure to be performed that determines the learner's level of mastery of the pedagogical information of the first lab step; and
isolate the learner from the virtual lab such that learner has no access to the virtual lab while the assessment procedure is being performed.

20. The system of claim 19, wherein the assessment procedure is performed by a second portion of the one or more computing resources.
